(19) United States
(12) Patent Application Publication
(10) Pub. No.: US 2017/0279500 A1
(43) Pub. Date: Sep. 28, 2017

(54) Antenna and Active Antenna System

(71) Applicant: Huawei Technologies Co., Ltd., Shenzhen (CN)

(72) Inventors: Jianping Zhao, Shanghai (CN); Xiao Xu, Shanghai (CN); Yang Geng, Shanghai (CN); Qiang Wang, Chengdu (CN); Xuan Xiao, Shanghai (CN)

(21) Appl. No.: 15/620,046

(22) Filed: Jun. 12, 2017

Related U.S. Application Data
(63) Continuation of application No. PCT/CN2015/083456, filed on Jul. 7, 2015.

(30) Foreign Application Priority Data
Dec. 11, 2014 (CN) 201410765868.0

(51) Int. Cl. H04B 7/04; H04B 7/08; H01Q 23/00; H04B 7/06

(52) U.S. Cl. CPC H04B 7/043; H04B 7/06; H04B 7/08; H04B 7/086; H01Q 23/00

(57) ABSTRACT

An antenna and an active antenna system to reduce complexity and power consumption of an antenna device, and reduce production costs, where the antenna includes an antenna array, a multichannel front-end, a multi-beam receiving network, and a multi-beam transmitting network. The antenna array includes w antenna elements, the multi-beam transmitting network is configured to perform beamforming processing on j transmit signal beams to obtain m transmit signals, the multichannel front-end is configured to convert w first radio-frequency signals received by the w antenna elements into n received signals, and convert the m transmit signals obtained by the multi-beam transmitting network into w second radio-frequency signals, where both n and m are less than or equal to w, and the multi-beam receiving network is configured to perform beamforming processing on the n received signals generated by the multichannel front-end to obtain k received signal beams.

### CROSS-REFERENCE TO RELATED APPLICATIONS

This application is a continuation of International Patent Application No. PCT/CN2015/083456 filed on Jul. 7, 2015, which claims priority to Chinese Patent Application No. 201410765868.0 filed on Dec. 11, 2014. The disclosures of the aforementioned applications are hereby incorporated by reference in their entireties.

### TECHNICAL FIELD

The present disclosure relates to the field of mobile communications, and in particular, to an antenna and an active antenna system.

### BACKGROUND

Performance of a wireless network needs to be constantly improved to meet an ever-increasing social requirement on a wireless bandwidth. Use of an active antenna system can not only obtain a high-gain beam and a high user multiplexing rate, but also can provide a diversity gain on multiple channels in order to obtain a high-performance wireless network. The active antenna system is gradually applied to a civilian technology.

The active antenna system uses a large-scale antenna array to form multiple antenna beams, and therefore, is also referred to as an active multiple-antenna system. A key technology of the active multiple-antenna system is beamforming of the antenna array. Coherent signals of multiple channels control, by means of digital domain signal processing, amplitudes and phases of all array element signals in the antenna array in order to perform spatial interference and superimposing to form a directional beam. The beam may be of a user-level or a cell-level. In a conventional technology architecture, one transceiver (TRX) drives one or more antenna units in order to form one active antenna module, and multiple modules form an array, that is, form an active antenna array. This is a so-called “one-drive-one” architecture. As shown in FIG. 1, on a transmit link, a first transmit signal reaches element 1# through TRX (1), and on a receive link, the first receive signal reaches receive channel processing through TRX (1). It can be seen that the first transmit signal and the first receive signal pass through symmetrical paths, and therefore, in the antenna, channels for receiving and transmitting signals are totally symmetrical in the “one-drive-one” architecture.

An antenna device including the antenna array in the “one-drive-one” solution has a complex structure, high power consumption, and high production costs.

### SUMMARY

The present disclosure provides an antenna and an active antenna system in order to reduce complexity and power consumption of an antenna device, and reduce production costs.

A first aspect of the present disclosure provides an antenna, including an antenna array, a multichannel front-end, a multi-beam receiving network, and a multi-beam transmitting network, wherein the antenna array includes w antenna elements, wherein the antenna element is configured to transmit or receive a radio-frequency signal, and w is a natural number greater than or equal to 2. The multi-beam transmitting network is configured to perform beamforming processing on j transmit signal beams in order to obtain m transmit signals, wherein j is a natural number. The multichannel front-end is configured to convert w first radio-frequency signals received by the w antenna elements into n received signals, and convert the m transmit signals obtained by the multi-beam transmitting network into w second radio-frequency signals, wherein both n and m are natural numbers less than or equal to w, and the multi-beam receiving network is configured to perform beamforming processing on the n received signals generated by the multichannel front-end in order to obtain k received signal beams, wherein k is a natural number.

With reference to the first aspect of the present disclosure, in a first implementation manner of the first aspect of the present disclosure, a same antenna element is used for transmitting or receiving a radio-frequency signal, and the multichannel front-end includes a filtering processing module configured to perform filtering processing on one first radio-frequency signal in the w first radio-frequency signals or on one second radio-frequency signal in the w second radio-frequency signals, a receive channel feeding network configured to form a receive channel, and perform first mapping processing on the w first radio-frequency signals in a receiving direction in order to obtain the n received signals, and a transmit channel feeding network configured to form a transmit channel, and perform second mapping processing on the m transmit signals in a transmission direction in order to obtain the w second radio-frequency signals.

With reference to the first implementation manner of the first aspect of the present disclosure, in a second implementation manner of the first aspect of the present disclosure, the multichannel front-end further includes a switch matrix configured to switch, in a time-division manner, the w first radio-frequency signals in the receiving direction and the w second radio-frequency signals in the transmission direction.

With reference to the first aspect of the present disclosure, in a third implementation manner of the first aspect of the present disclosure, different antenna elements are used for separately transmitting or receiving a radio-frequency signal, and the multichannel front-end includes w front-end channels, and the front-end channel includes a filtering processing module configured to perform filtering processing on one first radio-frequency signal in the w first radio-frequency signals or on one second radio-frequency signal in the w second radio-frequency signals.

With reference to the first aspect of the present disclosure, or the first implementation manner of the first aspect, or the second implementation manner of the first aspect, or the third implementation manner of the first aspect, in a fourth implementation manner of the first aspect, the multi-beam receiving network is further configured to perform beamforming processing on the n received signals generated by the multichannel front-end in order to obtain the k received signal beams corresponding to the n received signals, wherein k is equal to n.

With reference to the first aspect of the present disclosure, or the first implementation manner of the first aspect, or the second implementation manner of the first aspect, or the third implementation manner of the first aspect, in a fifth implementation manner of the first aspect, the multi-beam receiving network includes a radio-frequency amplitude and phase control module configured to perform amplitude adjustment and phase adjustment on the n received signals generated by the multichannel front-end, and a beam combination module configured to combine n amplitude-adjusted and phase-adjusted received signals into the k received signal beams, wherein k is greater than or equal to 1.

With reference to the first aspect of the present disclosure, or the first implementation manner of the first aspect, or the second implementation manner of the first aspect, or the third implementation manner of the first aspect, in a sixth implementation manner of the first aspect, the multi-beam receiving network includes a power division module configured to split each of the n received signals generated by the multichannel front-end into k received signals, and a beamforming module configured to separately select one signal from the k received signals split from each of the n received signals for combination in order to obtain the k received signal beams.

With reference to the first aspect of the present disclosure, or the first implementation manner of the first aspect, or the second implementation manner of the first aspect, or the third implementation manner of the first aspect, in a seventh implementation manner of the first aspect, the multi-beam transmitting network includes a bridge circuit configured to perform combination on the j transmit signal beams, and a phase-shift circuit configured to perform phase adjustment on j combined transmit signal beams in order to obtain the m transmit signals.

With reference to the first aspect of the present disclosure, or the first implementation manner of the first aspect, or the second implementation manner of the first aspect, or the third implementation manner of the first aspect, in an eighth implementation manner of the first aspect, the antenna further includes a low-noise amplification circuit configured to amplify one received signal in the n received signals.

A second aspect of the present disclosure provides an active antenna system, including any antenna in the foregoing, a transceiver unit, and a receive and transmit channel processing unit, wherein the transceiver unit is configured to process the k received signal beams generated by the multi-beam receiving network in order to obtain k corresponding digital signals, and output the k digital signals to the receive and transmit channel processing unit, and process j digital signals output by the receive and transmit channel processing unit in order to obtain the j corresponding transmit signal beams, and the receive and transmit channel processing unit is configured to perform decoding processing on the k digital signals generated by the transceiver unit, and perform encoding processing on a signal sent by a signal source in order to obtain the j digital signals, and output the j digital signals to the transceiver unit.

With reference to the second aspect of the present disclosure, in a first implementation manner of the second aspect, the transceiver unit includes k receiver modules corresponding to the k received signal beams and j transmitter modules corresponding to the j digital signals. The receiver module is configured to process one received signal beam generated by the multi-beam receiving network in order to obtain one corresponding digital signal, and the transmitter module is configured to process one digital signal output by the receive and transmit channel processing unit in order to obtain one corresponding transmit signal beam.

With reference to the first implementation manner of the second aspect of the present disclosure, in a second implementation manner of the second aspect of the present disclosure, the receive and transmit channel processing unit includes a receive channel processing module and a transmit channel processing module. The receive channel processing module is configured to perform decoding processing on the k digital signals generated by the k receiver modules, and the transmit channel processing module is configured to perform encoding processing on the signal sent by the signal source in order to obtain the j digital signals, and output the j digital signals respectively to the j corresponding transmitter modules.

It can be learned from the technical solutions that embodiments of the present disclosure have the following advantages. In a receiving direction, the multichannel front-end converts w first radio-frequency signals received by the w antenna elements into n received signals, and the multi-beam receiving network performs beamforming processing on the n received signals generated by the multichannel front-end in order to obtain k received signal beams. In a transmission direction, the multi-beam transmitting network performs beamforming processing on j transmit signal beams in order to obtain m transmit signals, and the multichannel front-end converts the m transmit signals obtained by the multi-beam transmitting network into the w second radio-frequency signals. Therefore, using an asymmetrical antenna array structure formed by separating signal reception and signal transmission, complexity and power consumption of an antenna device are reduced, and production costs are reduced.

### BRIEF DESCRIPTION OF DRAWINGS

FIG. 1 is a schematic structural diagram of an active antenna system;

FIG. 2 is a schematic structural diagram of an antenna according to an embodiment of the present disclosure;

FIG. 3 is a detailed schematic structural diagram of an antenna according to an embodiment of the present disclosure;

FIG. 4 is a schematic structural diagram of a multichannel front-end according to an embodiment of the present disclosure;

FIG. 5 is another schematic structural diagram of a multichannel front-end according to an embodiment of the present disclosure;

FIG. 6 is another schematic structural diagram of a multichannel front-end according to an embodiment of the present disclosure;

FIG. 7 is a schematic structural diagram of a front-end channel according to an embodiment of the present disclosure;

FIG. 8 is a schematic structural diagram of a multi-beam receiving network according to an embodiment of the present disclosure;

FIG. 9 is another schematic structural diagram of a multi-beam receiving network according to an embodiment of the present disclosure;

FIG. 10 is another schematic structural diagram of a multi-beam receiving network according to an embodiment of the present disclosure;

FIG. 11 is a schematic structural diagram of a multi-beam transmitting network according to an embodiment of the present disclosure;

FIG. 12 is a schematic structural diagram of an active antenna system according to an embodiment of the present disclosure; and

FIG. 13 is a detailed schematic structural diagram of an active antenna system according to an embodiment of the present disclosure.

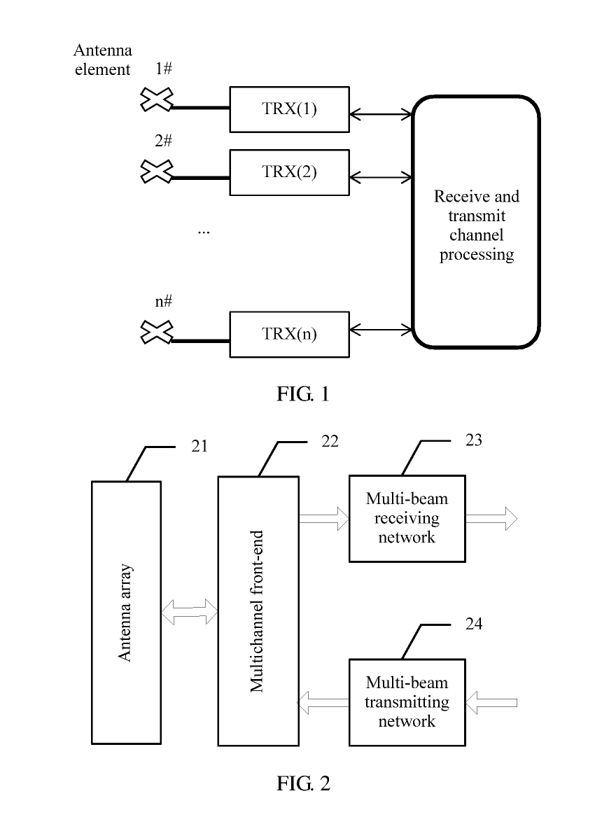

### DESCRIPTION OF EMBODIMENTS

To make the disclosure objectives, features, and advantages of the present disclosure clearer and more comprehensible, the following clearly describes the technical solutions in the embodiments of the present disclosure with reference to the accompanying drawings in the embodiments of the present disclosure. The embodiments described in the following are merely a part rather than all of the embodiments of the present disclosure. All other embodiments obtained by persons of ordinary skill in the art based on the embodiments of the present disclosure without creative efforts shall fall within the protection scope of the present disclosure.

Referring to FIG. 2, FIG. 2 is a schematic structural diagram of an antenna according to an embodiment of the present disclosure. The antenna includes an antenna array 21, a multichannel front-end 22, a multi-beam receiving network 23, and a multi-beam transmitting network 24.

The antenna array 21 includes w antenna elements, wherein the antenna element is configured to transmit or receive a radio-frequency signal, and w is a natural number greater than or equal to 2. The multi-beam transmitting network 24 is configured to perform beamforming processing on j transmit signal beams in order to obtain m transmit signals, wherein j is a natural number. The multichannel front-end 22 is configured to convert w first radio-frequency signals received by the w antenna elements into n received signals, and convert the m transmit signals obtained by the multi-beam transmitting network 24 into w second radio-frequency signals, wherein both n and m are natural numbers less than or equal to w, and the multi-beam receiving network 23 is configured to perform beamforming processing on the n received signals generated by the multichannel front-end 22 in order to obtain k received signal beams, wherein k is a natural number.

In this embodiment of the present disclosure, in a receiving direction, the multichannel front-end 22 converts the w first radio-frequency signals received by the w antenna elements into the n received signals, and the multi-beam receiving network 23 performs beamforming processing on the n received signals generated by the multichannel front-end 22 in order to obtain the k received signal beams. In a transmission direction, the multi-beam transmitting network 24 performs beamforming processing on the j transmit signal beams in order to obtain the m transmit signals, and the multichannel front-end 22 converts the m transmit signals obtained by the multi-beam transmitting network 24 into the w second radio-frequency signals. Therefore, using an asymmetrical antenna array structure formed by separating signal reception and signal transmission, complexity and power consumption of an antenna device are reduced, and production costs are reduced.

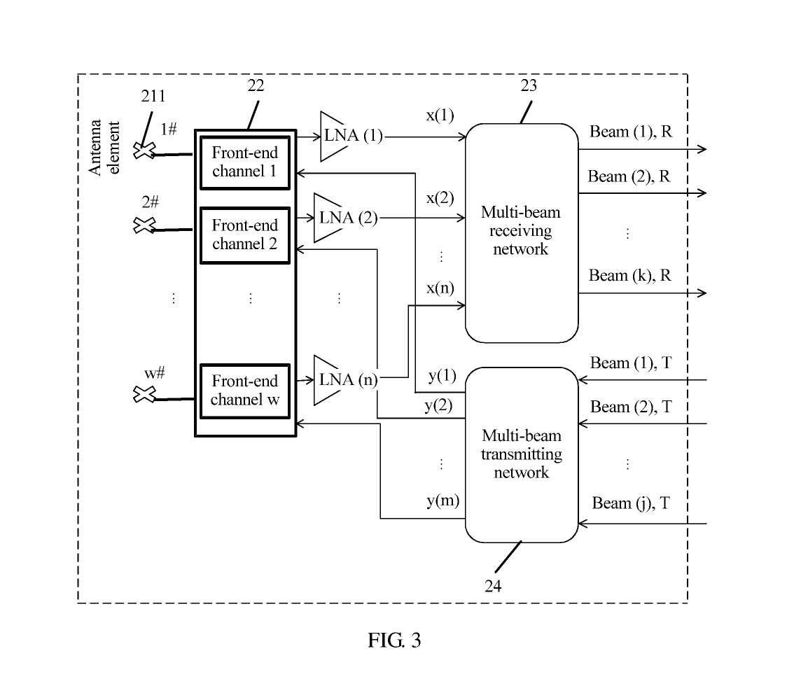

Referring to FIG. 3, FIG. 3 is a detailed schematic structural diagram of an antenna according to an embodiment of the present disclosure. The antenna array (not shown) includes at least two antenna elements 211. The antenna element 211 is configured to transmit and receive a radio-frequency signal. For a structure of the antenna element 211, refer to the other approaches. The antenna elements 211 may be arranged in parallel on the antenna. This is not described herein. When receiving a radio-frequency signal, the antenna array converts received w first radio-frequency signals into n received signals (x(1) to x(n) shown in FIG. 3) using the multichannel front-end 22, and when transmitting a radio-frequency signal, the antenna array converts, using the multichannel front-end 22, m transmit signals (y(1) to y(m) shown in FIG. 3) obtained by the multi-beam transmitting network 24 into w second radio-frequency signals, and then transmits the w second radio-frequency signals using the w antenna elements 211, wherein w is a natural number greater than or equal to 2, and both n and m are natural numbers less than or equal to w. Each antenna element 211 may be a single antenna element 211, or may be a set of antenna elements 211. Each antenna element 211 receives or transmits one radio-frequency signal. In FIG. 3, only one polarization of the antenna element 211 is processed in order to provide orthogonal signals and combine polarized signals in a receiving direction in order to increase a receive signal-to-noise ratio. Processing of another polarization is the same. For a specific processing manner, refer to the other approaches, and details are not described herein.

The multichannel front-end 22 separates a signal on a receive channel from a signal on a transmit channel. On the receive channel (that is, in the receiving direction), the w first radio-frequency signals received by the w antenna elements 211 are mapped (or combined) using the multichannel front-end 22 in order to obtain the n received signals. The n received signals are amplified using a low noise amplifier (LNA), and then the n received signals are sent to the multi-beam receiving network 23. Each (or each set of) antenna element 211 can receive or transmit only one radio-frequency signal, and therefore, the w (or w sets of) antenna elements can receive or transmit only w radio-frequency signals. Therefore, on the transmit channel (that is, in a transmission direction), the m transmit signals output from the multi-beam transmitting network 24 are mapped (or combined) using the multichannel front-end 22 in order to obtain the w second radio-frequency signals such that the w antenna elements receive the w second radio-frequency signals, and transmit the w second radio-frequency signals outward.

For a specific structure of the multichannel front-end 22, refer to the following.

1. Manner in which Receiving and Transmitting Share an Antenna Element

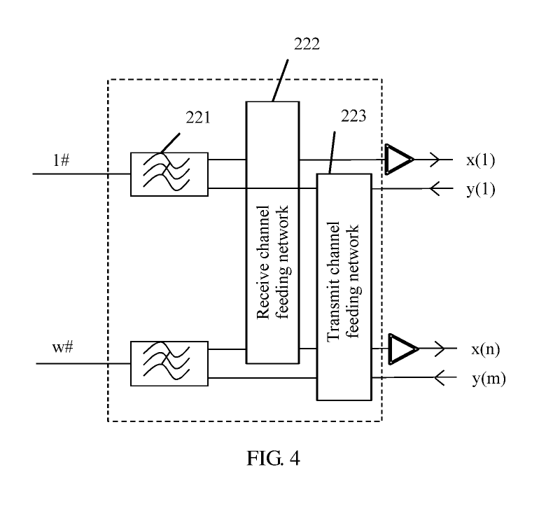

That receiving and transmitting share an antenna element 211 means that a same antenna element 211 is used for transmitting a radio-frequency signal or receiving a radio-frequency signal. Further, an antenna element 211 or a set of antenna elements 211 is used for both receiving a radio-frequency signal and transmitting a radio-frequency signal. Referring to FIG. 4, optionally, a multichannel front-end, such as the multichannel front-end 22 shown in FIG. 3 includes a filtering processing module 221 configured to perform filtering processing on one first radio-frequency signal in the w first radio-frequency signals or on one second radio-frequency signal in the w second radio-frequency signals, a receive channel feeding network 222 configured to form a receive channel, and perform first mapping processing on the w first radio-frequency signals in a receiving direction in order to obtain the n received signals, and a transmit channel feeding network 223 configured to form a transmit channel, and perform second mapping processing on the m transmit signals in a transmission direction in order to obtain the w second radio-frequency signals.

For a specific structure of the filtering processing module 221, refer to a structure of a filter in the other approaches, and the structure is not described herein. The filtering processing module 221 is configured to perform filtering processing on one first radio-frequency signal in the w first radio-frequency signals or on one second radio-frequency signal in the w second radio-frequency signals. This includes filtering interference, or performing out-of-band interference rejection and a low insertion loss on a transmitted spectrum, or isolating interference between a receive frequency and a transmit frequency such that a useful signal passes with attenuation as little as possible, and a useless signal is attenuated as much as possible.

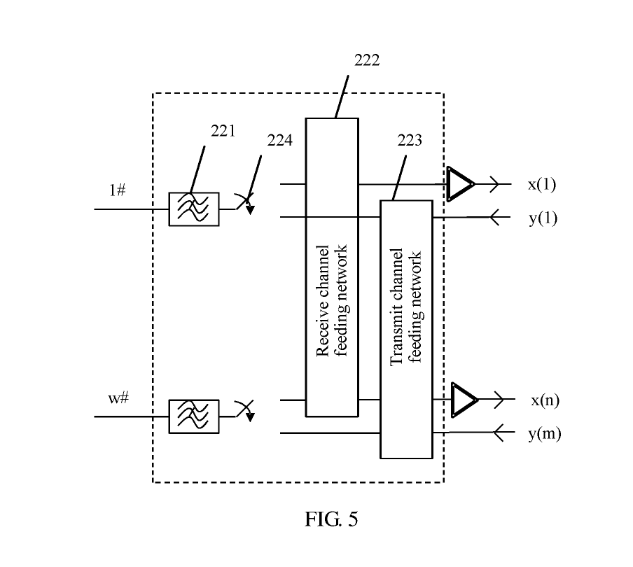

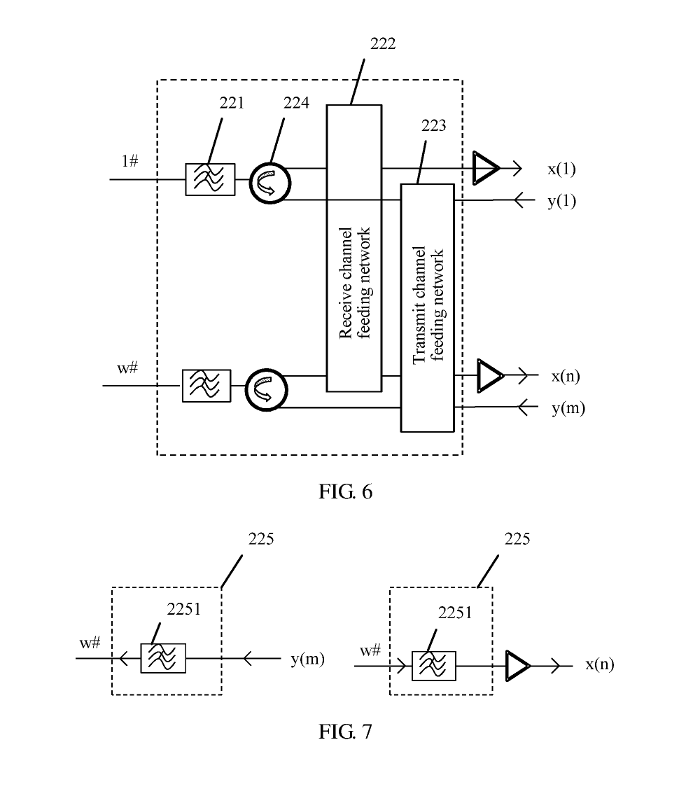

Referring to FIG. 5 and FIG. 6, optionally, a multichannel front-end, such as the multichannel front-end 22 shown in FIG. 3 further includes a switch matrix 224 configured to switch, in a time-division manner, the w first radio-frequency signals in the receiving direction and the w second radio-frequency signals in the transmission direction.

The switch matrix 224 is configured to switch, in a time-division manner, the w first radio-frequency signals in the receiving direction and the w second radio-frequency signals in the transmission direction, and when the w first radio-frequency signals in the receiving direction and the w second radio-frequency signals in the transmission direction share one (or one set of) antenna element, perform receive and transmit channel switching. The switch matrix 224 may be further implemented using a radio-frequency switch or a circulator. FIG. 5 is an implementation manner using a radio-frequency switch, and FIG. 6 is an implementation manner using a circulator. In this embodiment, only two implementation manners are enumerated, and a selection of the switch matrix 224 is not limited herein.

2. Manner in which Receiving and Transmitting do not Share an Antenna Element

That receiving and transmitting do not share an antenna element means that different antenna elements are used for separately transmitting a radio-frequency signal or receiving a radio-frequency signal. Further, a specific or a specific set of antenna elements 211 is used for only receiving a radio-frequency signal or used for only transmitting a radio-frequency signal. Referring to FIG. 7, optionally, a multichannel front-end, such as the multichannel front-end 22 shown in FIG. 3 includes w front-end channels 225. FIG. 7 shows structural diagrams of the front-end channels 225 in the transmission direction (namely, a y(m) direction) and in the receiving direction (namely, an x(n) direction).

The w front-end channels are distributed in an array manner, and each front-end channel includes one filtering processing module 2251 configured to perform filtering processing on the radio-frequency signal.

For a specific structure of the filtering processing module 2251, refer to a structure of a filter in the other approaches, and the structure is not described herein. The filtering processing module 2251 is configured to perform filtering processing on the radio-frequency signal such that a useful signal passes with attenuation as little as possible, and a useless signal is attenuated as much as possible.

The implementation manner of the multichannel front-end in the antenna is described in detail in the above, and the multi-beam receiving network in the antenna is described in the following.

Still referring to FIG. 3, for the multi-beam receiving network 23, refer to the following implementation manners.

### 1. Straight-Through Manner

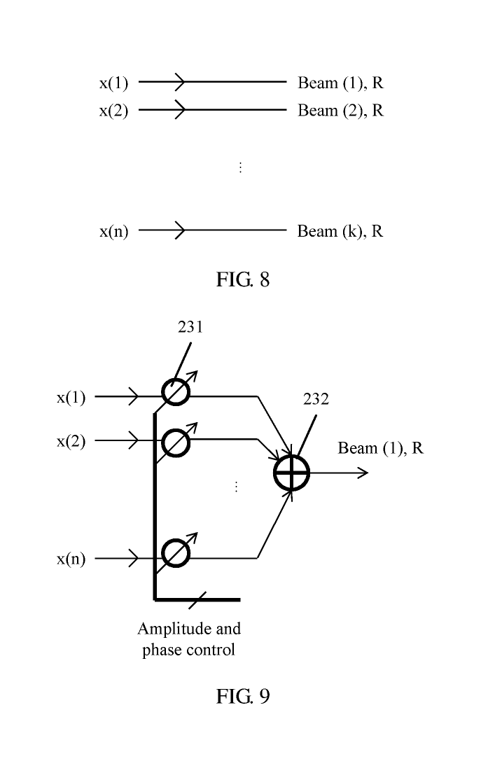

With reference to FIG. 3 and FIG. 8, optionally, in the straight-through manner, the multi-beam receiving network 23 is configured to perform beamforming processing on the n received signals (x(1) to x(n)) generated by the multichannel front-end 22 in order to obtain the k received signal beams {(Beam (1), R) to (Beam (k), R)} corresponding to the n received signals, wherein k is equal to n. In this case, a receive and transmit channel processing unit (not shown) on a back-end performs beamforming processing on the received signal beams.

### 2. Hybrid Manner

With reference to FIG. 3 and FIG. 9, optionally, in the hybrid manner, the multi-beam receiving network 23 includes a radio-frequency amplitude and phase control module 231 configured to perform amplitude adjustment and phase adjustment on the n received signals generated by the multichannel front-end 22, and a beam combination module 232 configured to combine n amplitude-adjusted and phase-adjusted received signals into the k received signal beams, wherein k is greater than or equal to 1.

It should be noted that in the hybrid manner, amplitudes and phases of the received signals are adjusted using a radio frequency amplitude and phase controller in the radio-frequency amplitude and phase control module 231, then the received signals are combined to obtain the received signal beams using the beam combination module 232, and the received signal beams are sent to the receive and transmit channel processing unit on the back-end for processing. In the implementation manner described in FIG. 9, the radio-frequency amplitude and phase control module 231 performs amplitude adjustment and phase adjustment on the n received signals generated by the multichannel front-end 22, and the beam combination module 232 combines n amplitude-adjusted and phase-adjusted received signals into one received signal beam, wherein the n received signals are signals received by n (or n sets of) antenna elements 211. In FIG. 9, only an example in which the n received signals (x(1) to x(n)) are combined into one received signal beam is described. A quantity of received signal beams may be single (one) or multiple, and this is not limited herein.

### 3. Passive Manner

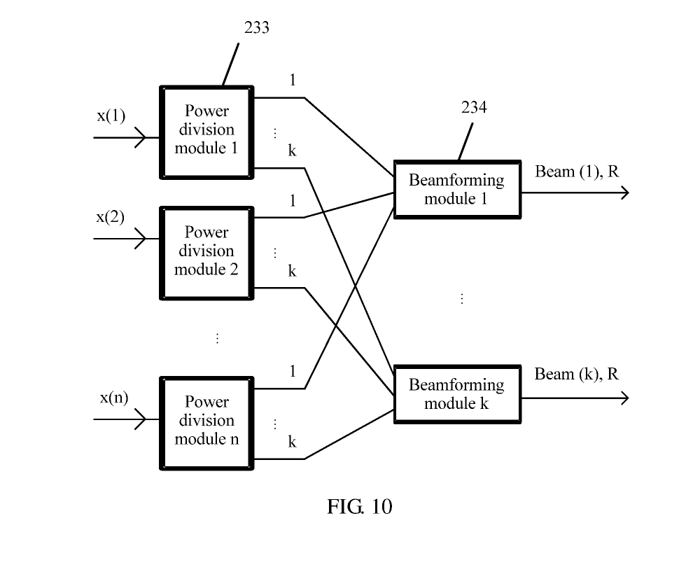

With reference to FIG. 3 and FIG. 10, optionally, in the passive manner, the multi-beam receiving network 23 includes a power division module 233 configured to split each of the n received signals generated by the multichannel front-end 22 into k received signals, and a beamforming module 234 configured to separately select one signal from the k received signals split from each of the n received signals for combination in order to obtain the k received signal beams.

It should be noted that in the passive manner, the power division module 233 splits each of the n received signals generated by the multichannel front-end 22 into k received signals, and the beamforming module 234 separately selects one signal from the k received signals split from each of the n received signals for combination in order to obtain the k received signal beams. In the implementation manner described in FIG. 10, n power division modules 233 (a power division module 1 to a power division module n shown in FIG. 10) respectively split the n received signals (x(1) to x(n)) generated by the multichannel front-end 22 into k received signals (1 to k), and each of k beamforming modules 234 (a beamforming module 1 to a beamforming module k shown in FIG. 10) selects one signal from the k received signals split from each of the n received signals for combination. It may be that the first to the k^{th} received signals split from each of the n received signals are combined into the k received signal beams {(Beam (1), R) to (Beam (k), R) shown in FIG. 10}, or may be combined in a hybrid manner, wherein k is a natural number, and a quantity of k received signal beams may be one or multiple.

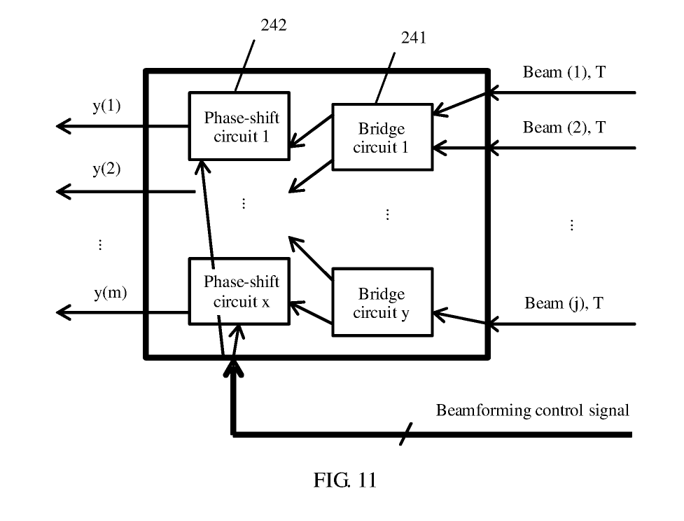

With reference to FIG. 3 and FIG. 11, the multi-beam transmitting network 24 includes a bridge circuit 241 configured to perform combination on the j transmit signal beams, and a phase-shift circuit 242 configured to perform phase adjustment on j combined transmit signal beams in order to obtain the m transmit signals.

It should be noted that bridge circuits 241 (a bridge circuit 1 to a bridge circuit y shown in FIG. 11) respectively perform combination on the j transmit signal beams {(Beam (1), T) to (Beam (k), T)}, and phase-shift circuits 242 (a phase-shift circuit 1 to a phase-shift circuit x shown in FIG. 11) perform, according to a beamforming control signal, phase adjustment on the j combined transmit signal beams in order to obtain the m corresponding transmit signals (y(1) to y(m) shown in FIG. 11). Quantities of x and y in the FIG. 11 may be set according to a system requirement, and are not limited herein.

The specific structure of the antenna is described in detailed in the above, and with reference to the antenna, an active antenna system including the antenna is described in the following.

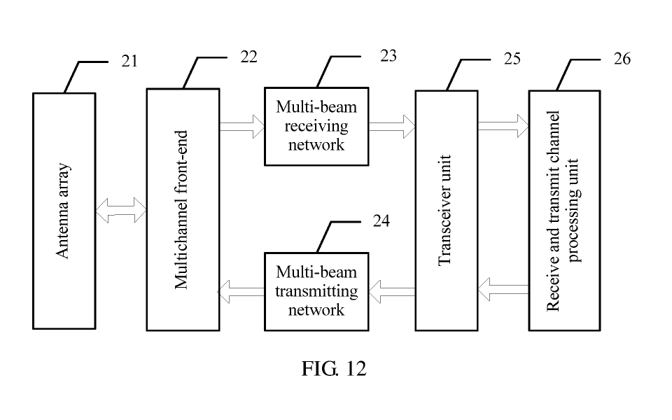

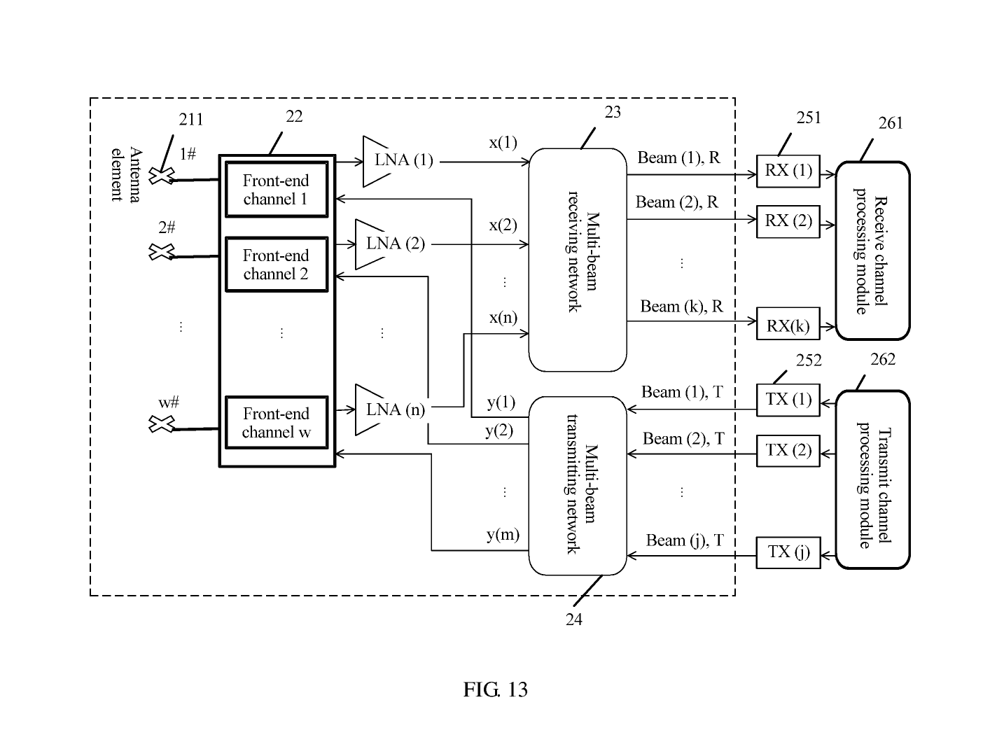

FIG. 12 is a schematic structural diagram of an active antenna system according to an embodiment of the present disclosure. FIG. 13 is a detailed schematic structural diagram of an active antenna system according to an embodiment of the present disclosure. The active antenna system is described with reference to the accompanying drawings.

The active antenna system provided in this embodiment of the present disclosure includes the antenna in the foregoing embodiments (shown in FIG. 2), a transceiver unit 25, and a receive and transmit channel processing unit 26.

The transceiver unit 25 is configured to process the k received signal beams generated by the multi-beam receiving network 23 in order to obtain k corresponding digital signals, and output the k digital signals to the receive and transmit channel processing unit 26, and process j digital signals output by the receive and transmit channel processing unit 26 in order to obtain j corresponding transmit signal beams, and the receive and transmit channel processing unit 26 is configured to perform decoding processing on the k digital signals generated by the transceiver unit 25, and perform encoding processing on a signal sent by a signal source in order to obtain the j digital signals and output the j digital signals to the transceiver unit 25.

In this embodiment of the present disclosure, in a receiving direction, the multichannel front-end 22 converts w first radio-frequency signals received by the w antenna elements into n received signals. The multi-beam receiving network 23 performs beamforming processing on the n received signals generated by the multichannel front-end 22 in order to obtain k received signal beams. The transceiver unit 25 processes the k received signal beams generated by the multi-beam receiving network 23 in order to obtain k corresponding digital signals, and outputs the k digital signals to the receive and transmit channel processing unit 26, and the receive and transmit channel processing unit 26 performs decoding processing on the k digital signals generated by the transceiver unit 25. In a transmission direction, the receive and transmit channel processing unit 26 performs encoding processing on the signal sent by the signal source in order to obtain the j digital signals, and outputs the j digital signals to the transceiver unit 25. The transceiver unit 25 processes the j digital signals output by the receive and transmit channel processing unit 26 in order to obtain the j corresponding transmit signal beams. The multi-beam transmitting network 24 performs beamforming processing on the j transmit signal beams in order to obtain m transmit signals, and the multichannel front-end 22 converts the m transmit signals obtained by the multi-beam transmitting network 24 into the w second radio-frequency signals. Therefore, using an asymmetrical antenna array structure formed by separating signal reception and signal transmission, complexity and power consumption of an antenna device are reduced, and production costs are reduced.

Further, as shown in FIG. 13, with reference to the FIG. 12, in this embodiment of the present disclosure, the transceiver unit 25 includes k receiver modules 251 corresponding to the k received signal beams and j transmitter modules 252 corresponding to the j digital signals. The receiver module 251 is configured to process one received signal beam generated by the multi-beam receiving network 23 in order to obtain one corresponding digital signal, and the transmitter module 252 is configured to process one digital signal output by the receive and transmit channel processing unit 26 in order to obtain one corresponding transmit signal beam.

It should be noted that as shown in FIG. 13, the k receiver modules 251 (designated as RX(1) to RX(k) in FIG. 13) respectively process the k received signal beams {(Beam (1), R) to (Beam (k), R) shown in FIG. 13} in order to obtain the k corresponding digital signals. A processing process mainly includes performing amplification, filtering, frequency conversion, analog-to-digital conversion, digital intermediate frequency processing, and the like on the received signal beam. For details, refer to the other approaches, and details are not described herein. As shown in FIG. 13, the j transmitter modules 252 (designated as TX(1) to TX(j) in FIG. 13) respectively process the j digital signals output by the receive and transmit channel processing unit (not shown) in order to obtain the j corresponding transmit signal beams {(Beam (1), T) to (Beam (j), T) shown in FIG. 13}. A processing process mainly includes performing digital-to-analog conversion, frequency conversion, filtering, and the like on the digital signal, and this is not further described herein.

Still referring to FIG. 13, the receive and transmit channel processing unit includes a receive channel processing module 261 and a transmit channel processing module 262.

The receive channel processing module 261 is configured to perform decoding processing on the k digital signals generated by the k receiver modules 251, and the transmit channel processing module 262 is configured to perform encoding processing on the signal sent by the signal source in order to obtain the j digital signals, and output the j digital signals respectively to the j corresponding transmitter modules 252.

It should be noted that the receive channel processing module 261 performs decoding processing on the k digital signals generated by the k receiver modules 251. A processing process mainly includes digital baseband processing, such as demodulation and decoding in order to obtain a signal meeting a system requirement. The transmit channel processing module 262 performs encoding processing on the signal sent by the signal source in order to obtain the j digital signals, and outputs the j digital signals respectively to the j corresponding transmitter modules 252. The signal source is a base station, and after performing encoding processing on the signal sent by the base station, the transmit channel processing module outputs a digital signal obtained by means of encoding to a corresponding transmitter module 252.

Processes of receiving a radio-frequency signal and transmitting a radio-frequency signal of the active antenna system provided in this embodiment of the present disclosure are as follows.

When receiving a radio-frequency signal, the w antenna elements 211 in the antenna convert received w first radio-frequency signals into n received signals using the multichannel front-end 22. The multi-beam receiving network 23 performs beamforming processing on the n received signals generated by the multichannel front-end 22 in order to obtain k received signal beams. The transceiver unit 25 processes the k received signal beams generated by the multi-beam receiving network 23 in order to obtain k corresponding digital signals, and outputs the k digital signals to the receive and transmit channel processing unit 26. The receive and transmit channel processing unit 26 performs decoding processing on the k digital signals generated by the transceiver unit 25, and finally, k decoded digital signals are transmitted to a baseband unit.

When transmitting a radio-frequency signal, the receive and transmit channel processing unit 26 performs encoding processing on a signal sent by a signal source in order to obtain the j digital signals, and outputs the j digital signals to the transceiver unit 25. The transceiver unit 25 processes the j digital signals output by the receive and transmit channel processing unit 26 in order to obtain j corresponding transmit signal beams. The multi-beam transmitting network 24 performs beamforming processing on the j transmit signal beams generated by the transceiver unit 25 in order to obtain m transmit signals. The multichannel front-end 22 converts the m transmit signals obtained by the multi-beam transmitting network 24 into the w second radio-frequency signals, and finally, the w antenna elements respectively transmit the w second radio-frequency signals.

The foregoing embodiments are merely intended for describing the technical solutions of the present disclosure, but not for limiting the present disclosure. Although the present disclosure is described in detail with reference to the foregoing embodiments, persons of ordinary skill in the art should understand that they may still make modifications to the technical solutions described in the foregoing embodiments or make equivalent replacements to some technical features thereof, without departing from the spirit and scope of the technical solutions of the embodiments of the present disclosure.

What is claimed is:

1. An antenna, comprising:
an antenna array comprising w antenna elements, wherein each antenna element is configured to transmit or receive a radio-frequency signal, and wherein w is a natural number greater than or equal to 2;
a multichannel front-end coupled to the antenna array;
a multi-beam receiving network coupled to the multichannel front-end; and
a multi-beam transmitting network coupled to the multichannel front-end and configured to perform beamforming processing on j transmit signal beams to obtain m transmit signals, wherein j is a natural number, and wherein m is a natural number less than or equal to w,
wherein the multichannel front-end is configured to:
convert w first radio-frequency signals received by the w antenna elements into n received signals wherein n is a natural number less than or equal to w; and
convert the m transmit signals obtained by the multi-beam transmitting network into w second radio-frequency signals,
wherein the multi-beam receiving network is configured to perform beamforming processing on the n received signals generated by the multichannel front-end to obtain k received signal beams, and wherein k is a natural number.

2. The antenna according to claim 1, wherein a same one of the w antenna elements is used for transmitting or receiving the radio-frequency signal, and wherein the multichannel front-end comprises:
a filtering processor configured to perform filter processing on one first radio-frequency signal in the w first radio-frequency signals;
a receive channel feeding network coupled to the filtering processor and configured to:
form a receive channel; and
perform first mapping processing on the w first radio-frequency signals in a receiving direction to obtain the n received signals; and
a transmit channel feeding network coupled to the filtering processor and configured to:
form a transmit channel; and
perform second mapping processing on the m transmit signals in a transmission direction to obtain the w second radio-frequency signals.

3. The antenna according to claim 1, wherein a same one of the w antenna elements is used for transmitting or receiving the radio-frequency signal, and wherein the multichannel front-end comprises:
a filtering processor configured to perform filter processing on one second radio-frequency signal in the w second radio-frequency signals;
a receive channel feeding network coupled to the filtering processor and configured to:
form a receive channel; and
perform first mapping processing on the w first radio-frequency signals in a receiving direction to obtain the n received signals; and
a transmit channel feeding network coupled to the filtering processor and configured to:
form a transmit channel; and
perform second mapping processing on the m transmit signals in a transmission direction to obtain the w second radio-frequency signals.

4. The antenna according to claim 2, wherein the multichannel front-end further comprises a switch matrix configured to switch, in a time-division manner, the w first radio-frequency signals in the receiving direction.

5. The antenna according to claim 3, wherein the multichannel front-end further comprises a switch matrix configured to switch, in a time-division manner, the w second radio-frequency signals in the transmission direction.

6. The antenna according to claim 1, wherein different antenna elements are used for separately transmitting or receiving the radio-frequency signal, wherein the multichannel front-end comprises w front-end channels, and wherein each front-end channel comprises a filtering processor configured to perform filter processing on one first radio-frequency signal in the w first radio-frequency signals.

7. The antenna according to claim 1, wherein different antenna elements are used for separately transmitting or receiving the radio-frequency signal, wherein the multichannel front-end comprises w front-end channels, and wherein each front-end channel comprises a filtering processor configured to perform filter processing on one second radio-frequency signal in the w second radio-frequency signals.

8. The antenna according to claim 1, wherein the multi-beam receiving network is further configured to perform beamforming processing on the n received signals generated by the multichannel front-end to obtain the k received signal beams corresponding to the n received signals, wherein k is equal to n.

9. The antenna according to claim 1, wherein the multi-beam receiving network comprises:
a memory comprising instructions; and
a processor coupled to the memory, wherein the instructions cause the processor to be configured to:
perform amplitude adjustment and phase adjustment on the n received signals generated by the multichannel front-end; and
combine n amplitude-adjusted and phase-adjusted received signals into the k received signal beams, wherein k is greater than 1.

10. The antenna according to claim 1, wherein the multi-beam receiving network comprises:
a memory comprising instructions; and
a processor coupled to the memory, wherein the instructions cause the processor to be configured to:
perform amplitude adjustment and phase adjustment on the n received signals generated by the multichannel front-end; and
combine n amplitude-adjusted and phase-adjusted received signals into the k received signal beams, wherein k is equal to 1.

11. The antenna according to claim 1, wherein the multi-beam receiving network comprises:
a memory comprising instructions; and
a processor coupled to the memory, wherein the instructions cause the processor to be configured to:
split each of the n received signals generated by the multichannel front-end into k received signals; and
separately select one signal from the k received signals split from each of the n received signals for combination to obtain the k received signal beams.

12. The antenna according to claim 1, wherein the multi-beam transmitting network comprises:
a memory comprising instructions; and
a processor coupled to the memory, wherein the instructions cause the processor to be configured to:
perform combination on the j transmit signal beams; and
perform phase adjustment on the j combined transmit signal beams to obtain the m transmit signals.

13. The antenna according to claim 1, further comprising a low-noise amplification circuit coupled to the multichannel front-end and configured to amplify one received signal in the n received signals.

14. An active antenna system, comprising:
an antenna comprising:
an antenna array comprising w antenna elements, wherein each antenna element is configured to transmit or receive a radio-frequency signal, and wherein w is a natural number greater than or equal to 2;
a multichannel front-end coupled to the antenna array;
a multi-beam receiving network coupled to the multichannel front-end; and
a multi-beam transmitting network coupled to the multichannel front-end and configured to perform beamforming processing on j transmit signal beams to obtain m transmit signals, wherein j is a natural number, wherein m is a natural number less than or equal to w,
wherein the multichannel front-end is configured to:
convert w first radio-frequency signals received by the w antenna elements into n received signals, wherein n is a natural number less than or equal to w; and
convert the m transmit signals obtained by the multi-beam transmitting network into w second radio-frequency signals,
wherein the multi-beam receiving network is configured to perform beamforming processing on the n received signals generated by the multichannel front-end to obtain k received signal beams, and wherein k is a natural number a transceiver coupled to the antenna and configured to:
process the k received signal beams generated by the multi-beam receiving network to obtain k corresponding digital signals;
output the k digital signals to a receive and transmit channel processor; and
process j digital signals output by the receive and transmit channel processor to obtain the j corresponding transmit signal beams, and
wherein the receive and transmit channel processor is configured to:
perform decoding processing on the k digital signals generated by the transceiver;
perform encoding processing on a signal from a signal source to obtain the j digital signals; and
output the j digital signals to the transceiver.

15. The active antenna system according to claim 14, wherein the transceiver comprises k receivers corresponding to the k received signal beams and j transmitters corresponding to the j digital signals,
wherein a receiver is configured to process one received signal beam generated by the multi-beam receiving network to obtain one corresponding digital signal, and
wherein a transmitter is configured to process one digital signal output by the receive and transmit channel processor to obtain one corresponding transmit signal beam.

16. The active antenna system according to claim 15, wherein the receive and transmit channel processor comprises a receive channel processor and a transmit channel processor,
wherein the receive channel processor is configured to perform decoding processing on the k digital signals generated by the k receivers, and
wherein the transmit channel processor is configured to:
perform encoding processing on the signal sent by the signal source to obtain the j digital signals; and
output the j digital signals respectively to the j corresponding transmitters.
